(19) United States
(12) Patent Application Publication
(10) Pub. No.: US 2018/0122060 A1
(43) Pub. Date: May 3, 2018

(54) AUTOMATED INSPECTION PROTOCOL FOR COMPOSITE COMPONENTS

(71) Applicant: Rolls-Royce Corporation, Indianapolis, IN (US)

(72) Inventors: Amir Houshang Shirkhodaie, Nashville, TN (US); Joseph Peter Henderkott, Westfield, IN (US)

(21) Appl. No.: 15/800,629

(22) Filed: Nov. 1, 2017

Related U.S. Application Data
(60) Provisional application No. 62/416,551, filed on Nov. 2, 2016.

(51) Int. Cl. G06T 7/00; B28B 17/00; H04N 5/225; G06K 9/46; G06T 7/11; G01N 21/88

(52) U.S. Cl. CPC G06T 7/001; B28B 17/0072; H04N 5/2256; G01N 2021/8887; G06T 7/11; G01N 21/8851; G06T 2207/30164; G06K 9/4604

(57) ABSTRACT

A protocol-based inspection system that includes an illumination system, an imaging system configured to capture a surface image of a composite component based on illumination of the composite component using visible light, a component mount configured to rotate the composite component relative to at least the imaging system, and a computing device configured to perform an automated inspection protocol to cause the illumination system to illuminate the composite component using visible light, cause the imaging system to capture at least one surface image of the composite component in response to the illumination of the composite component using the visible light, perform a fuzzy logic analysis on the at least one surface image to detect a surface defect on the composite component that includes a fiber tow mis-weave, an exposed fiber tow, or a surface nodule, and output an indication of the surface defect via a user interface.

This application claims the benefit of U.S. Provisional Application No. 62/416,551 filed Nov. 2, 2016, which is incorporated herein by reference in its entirety.

### TECHNICAL FIELD

The present disclosure relates to inspection techniques for ceramic or ceramic matrix composite components.

### BACKGROUND

Composite component such as ceramic matrix composite (CMC) components may be formed from an underlying fiber preform infiltrated with a ceramic material. Such composite components may be useful for high temperature applications inducing useful as components for gas turbine engines used in aerospace applications. In some examples, the composite components may suffer from one or more surface defects as a result of the manufacturing process. Due to the textured surface of such composite components, detection of such surface defects may be difficult.

### SUMMARY

In some examples, the disclosure describes a protocol-based inspection system that includes an illumination system, an imaging system configured to capture a surface image of a composite component (e.g., CMC) based on illumination of the composite component using visible light, a component mount configured to rotate the composite component relative to at least the imaging system, and a computing device configured to perform an automated inspection protocol to cause the illumination system to illuminate the composite component using visible light, cause the imaging system to capture at least one surface image of the composite component in response to the illumination of the composite component using the visible light, perform a fuzzy logic analysis on the at least one surface image to detect a surface defect on the composite component that includes a fiber tow mis-weave, an exposed fiber tow, or a surface nodule, and output an indication of the surface defect via a user interface.

In some examples, the disclose describes a technique that includes receiving, by a computing device, an indication of an input from a user interface to select an automated inspection protocol; causing, by the computing device, an illumination system to output visible light to illuminate a composite component using visible light; causing, by the computing device, an imaging system to capture at least one surface image of the composite component in response to the illumination of the composite component using the visible light; performing, by the computing device, a fuzzy logic analysis on the at least one surface image to detect a surface defect on the composite component that includes a fiber tow mis-weave, an exposed fiber tow, or a surface nodule; and outputting, by the computing device, an indication of the surface defect via the user interface.

In some examples, the disclose describes a computer readable storage medium that includes instructions that, when executed, cause at least one processor to receive, from an imaging system, at least one surface image of a composite component illuminated by visible light, perform a fuzzy logic analysis on the at least one surface image to detect a surface defect on the composite component that includes a fiber tow mis-weave, an exposed fiber tow, a surface nodule, and output an indication of the surface defect via a user interface.

The details of one or more examples are set forth in the accompanying drawings and the description below. Other features, objects, and advantages will be apparent from the description and drawings, and from the claims.

### BRIEF DESCRIPTION OF THE FIGURES

FIG. 1 is a schematic illustration of an example protocol-based inspection system for a visual, non-destructive evaluation of a composite component.

FIG. 2 is a conceptual block diagram illustrating an example of a computing device for analyzing a composite component by performing an automated inspection protocol.

FIG. 3 is a flow diagram illustrating an example automated inspection protocol that may be performed using the protocol-based inspection system of FIG. 1.

FIG. 4 are digital images taken of a CMC component that includes woven tows that have been infiltrated with silicon and include a surface defect in the form of insufficient tow coverage.

FIG. 5 are digital images taken of a CMC component that includes woven tows that have been infiltrated with silicon and include a surface defect in the form of a silicon nodule.

FIG. 6 is flow diagram illustrating an example technique for performing automated inspection protocol using protocol-based inspection system.

### DETAILED DESCRIPTION

In some examples, the disclosure describes a unique protocol-based inspection system for a visual, non-destructive evaluation of a composite component (e.g., ceramic or ceramic matrix composites (CMCs)) that may be used, for example, in aerospace applications. Unlike other, metal, alloy, or single crystalline components, CMCs possess a unique set of surface characteristics making the visual inspection of such components particularly challenging due to, for example, non-uniform surface structures, highly reflective surfaces, specific CMC based defects, and the like. The protocol-based inspection systems described herein may be useful to address such composite-specific challenges to visually inspect such components for the presence of anomalies or defects. In some examples, the protocol-based inspection system may compare such anomalies or defects to a target standard to determine whether the anomaly or defect is acceptable or violates protocol standards. In some examples, the protocol-based inspection system may be automated, evaluating multiple surfaces of the composite component to ensure the component satisfies protocol standards and is suitable for its intended use.

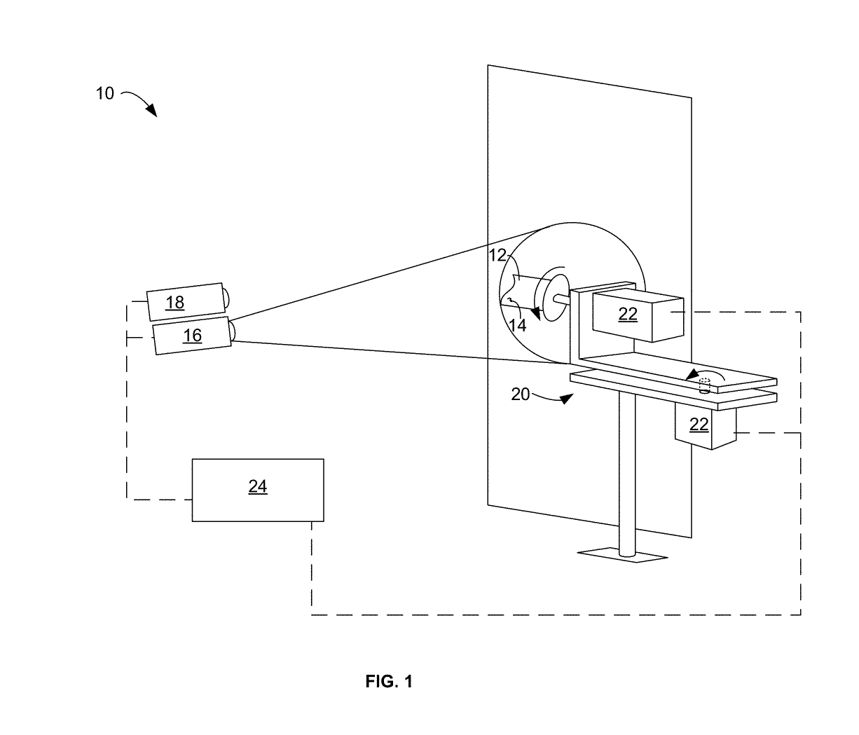

FIG. 1 is a schematic illustration of an example protocol-based inspection system 10 for a visual, non-destructive evaluation of a composite component 12 that may be used to image a composite component 12 to determine the presence of one or more surface defects 14 on composite component 12. In some examples, protocol-based inspection system 10 may include an illumination system 16, an imaging system 18, a component mount 20 for receiving composite component 12 that may include at least one servo motor 22 configured to rotate composite component 12 relative to at least one of the imaging system 18 or illumination system 16, and a computing device 24. Protocol-based inspection system 10 may be operated via computing device 24 to perform an automated inspection protocol to detect, characterize, and report the presence of surface defects 14 on composite component 12.

Illumination system 16 of protocol-based inspection system 10 may include any suitable illumination source configured to illuminate one or more surfaces of composite component 12 for imaging system 18 to take a digital image of the surfaces of composite component 12. Illumination system 16 may include any suitable source of defused radiance to illuminate composite component 12. In some examples, illumination system 16 may include conventional light or the like. For example, illumination system 16 may include one or more fluorescent lights to illuminate composite component 12 within visible light (e.g., 400-700 nm range) or white light range. The radiance can be reflected by the surface of composite component 12 and towards imaging system 18. In some examples, illumination system 16 may also include one or more film assemblies (e.g., optical filters, light diffusers, or the like; not shown) configured to modify the illumination of composite component 12. For examples a light diffuser may be positioned between composite component 12 and illumination system 16 to further smooth and neutralize the radiance of illumination system 16.

Imaging system 18 may include any suitable system that can be used to acquire a digital image of composite component 12. In some examples, imaging system 18 may include one or more digital cameras configured to take digital images of one or more surfaces of composite component 12 in response to the performance of the automated inspection protocol.

Component mount 20 may include any suitable electro-mechanical assembly designed to receive and hold composite component 12 in a position relative to imaging system 18 and illumination system 16. In some examples, component mount 20 may include a multi-axis platform connected to one or more servo motors 22 that maneuver composite component 12 relative to imaging system 18 to allow imaging system 18 to acquire digital images of composite component along various surfaces and angles.

Composite component 12 may include any composite-based component including, but not limited to, CMC components for aerospace applications such as airfoils of gas turbine engine assemblies. Example composite components may include fiber-based CMC components formed from a fiber preform that has undergone melt infiltration, such as silicon melt infiltration. The fiber structure of fiber preform may include any suitable architectural arrangement of fibers including, for example, a continuous or discontinuous, woven or non-woven fibers and may be in the form of tows, whiskers, platelets, particulates or the like. In some examples, the fibers may be arranged as one or more layers of fibers such as a multilayer stack of woven fabrics bound together. Any suitable fiber material may be used to form the fiber preform for composite component 12 including, for example, SiC, Si₃N4, Al₂O₃, aluminosilicate, SiO₂, or the like. In some examples, the fiber preform used to form composite component 12 may include precursor fibers that are converted during processing to a suitable fiber material. In some examples, the fiber preform may be coated with an optional fiber interface material to rigidize or densify the fiber preform. Suitable interface materials may include, for example, pyrolytic carbon (PyC), boron nitride (BN), or the like and may be deposited using any suitable technique such as chemical vapor infiltration (CVI), chemical vapor deposition (CVD), or the like.

Composite component 12 may represent the final machined form or a mid-fabrication state of the component, such as after melt infiltration but prior to being machined to desired, final size.

In contrast to alternative materials that may be used to form components for gas turbine engine assemblies, such as metal, alloy, or single crystalline materials; composite components possess a unique set to structural features that may not be present on the non-composite components. For example, composite component 12 may include an embossed or textured surface that may be the result of the underlying fiber architecture (e.g., woven fibers/tows producing a woven-patterned surface), highly reflective surfaces as a result of the underlying materials used to form composite component 12 compared the materials used in non-composite counterpart components, surface defects 14 associated with the fiber architecture (e.g., broken fibers, weave defects, or the like), surface defects 14 associated with infiltration techniques (e.g., the formation of nodules or protrusions (e.g., silicon nodules)) that are formed on the surface of composite component 12 as a consequence of the infiltration process, surface defects 14 associated with layer integrity (e.g., topical exposure of one or more fibers through a melt infiltrant layer), or the like. The various operational protocols described below may be used to evaluate such surface defects 14 associated with composite components. While protocol-based inspection system 10 may be used to identify surface defects 14 specific to composite components, the inspection protocol may also identify more general manufacturing type defects including, for example, nicks, marks, cracks, scores, dents, and the like.

In some examples, the automated inspection protocol to be performed by protocol-based inspection system 10, as described below, may be performed on the different stages during the manufacturing composite component 12. For example, operational protocols relating to assessing the fiber architecture of composite component 12 (e.g., detecting the presence of fiber tow mis-weaves) may be performed to detect critical surface defects 14 (e.g., such that composite component 12 would be unsuitable for use) prior to the melt infiltration cycle to help reduce or avoid unnecessary manufacturing costs.

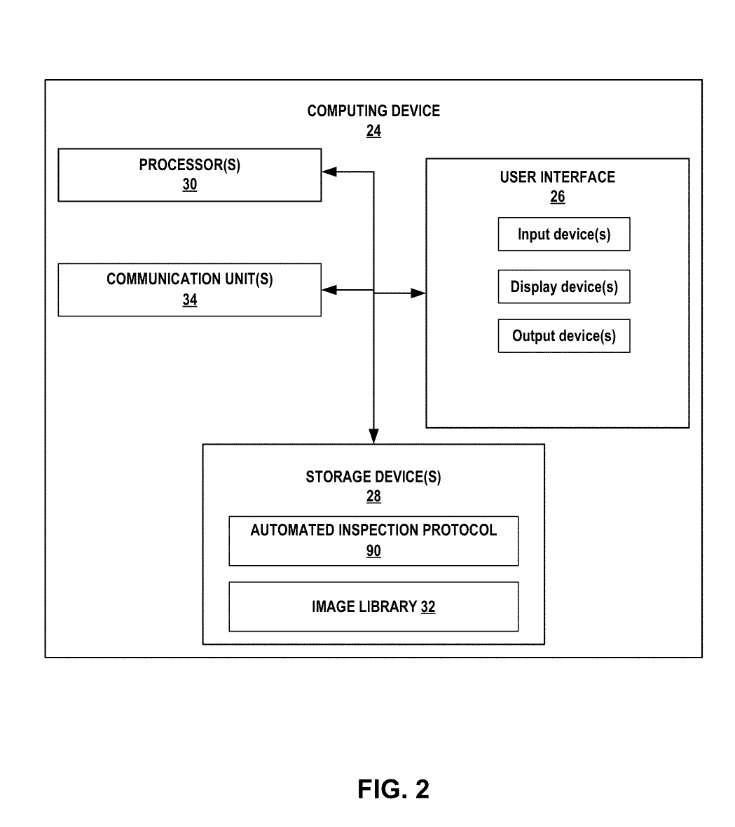

Protocol-based inspection system 10 may include computing device 24 configured to utilize and control illumination system 16, imaging system 18, and component mount 20 to perform an automated inspection protocol to detect and characterize the presence surface defects 14 on the surface of composite component 12 being inspected. FIG. 2 is a conceptual block diagram illustrating an example of computing device 24 illustrated in FIG. 1. In some examples, computing device 24 may include, for example, a desktop computer, a laptop computer, a workstation, a server, a mainframe, a cloud computing system, or the like. In some examples, computing device 24 controls the operation of protocol-based inspection system in response to user input via user interface 26.

In the example illustrated in FIG. 2, computing device 24 includes one or more processors 30, one or more storage devices 28, one or more communication units 34, and a user interface 26 which may include one or more input devices, one or more display devices, one or more output devices, and the like. In some examples, one or more storage devices 28 stores an automated inspection protocol 90 and one or more image libraries 32. In other examples, computing device 24 may include additional components or fewer components than those illustrated in FIG. 2.

One or more processors 30 are configured to implement functionality and/or process instructions for execution within computing device 24. For example, processor(s) 30 may be capable of processing instructions stored by storage device 28. Examples of one or more processors 30 may include, any one or more of a microprocessor, a controller, a digital signal processor (DSP), an application specific integrated circuit (ASIC), a field-programmable gate array (FPGA), or other digital logic circuitry. The techniques performed by computing device 24 described in this disclosure may be implemented, at least in part, in hardware, software, firmware, or any combination thereof. For example, various aspects of the described techniques may be implemented within one or more processors 30, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit including hardware may also perform one or more of the techniques of this disclosure.

Such hardware, software, and firmware of computing device 24 may be implemented within the same device or within separate devices to support the various techniques described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware, firmware, or software components. Rather, functionality associated with one or more modules or units may be performed by separate hardware, firmware, or software components, or integrated within common or separate hardware, firmware, or software components.

Computing device 24 includes user interface 26, which may include one or more input devices. Input devices, in some examples, are configured to receive input from a user through tactile, audio, or video sources. Examples of input devices include a mouse, a keyboard, a voice responsive system, video camera, microphone, touchscreen, or any other type of device for receiving a command from a user.

User interface 26 may further include one or more output devices. Output devices, in some examples, are configured to provide output to a user using audio or video media. For example, output devices may include a display, a sound card, a video graphics adapter card, a printer, or any other type of device for converting a signal into an appropriate form understandable to humans or machines. In some example, computing device 24 outputs a report reflecting results of the automated inspection protocol 90 performed on composite component 12.

Computing device 24 further includes one or more communication units 34. Computing device 24 may utilize communication units 34 to communicate with external devices (e.g., component of protocol-based inspection system 10) via one or more networks, such as one or more wired or wireless networks. Communication unit 34 may include a network interface card, such as an Ethernet card, an optical transceiver, a radio frequency transceiver, or any other type of device that can send and receive information. Other examples of such network interfaces may include WiFi radios or Universal Serial Bus (USB). In some examples, computing device 24 utilizes communication units 34 to wirelessly communicate with an external device such as a server.

Computer device 24 includes one or more storage devices 28, which may be configured to store information within computing device 24 during operation. Storage device(s) 28, in some examples, include a computer-readable storage medium or computer-readable storage device. In some examples, storage device 28 includes a temporary memory, meaning that a primary purpose of storage device 28 is not long-term storage. Storage device 28, in some examples, includes a volatile memory, meaning that storage device 28 does not maintain stored contents when power is not provided to storage device 28. Examples of volatile memories include random access memories (RAM), dynamic random access memories (DRAM), static random access memories (SRAM), and other forms of volatile memories known in the art. In some examples, storage device 28 is used to store program instructions for execution by processor 30. Storage device 28, in some examples, is used by software or applications running on computing device 24 to temporarily store information during program execution.

In some examples, storage device(s) 28 may further include one or more devices configured for longer-term storage of information. In some examples, storage device 28 include non-volatile storage elements. Examples of such non-volatile storage elements include magnetic hard discs, optical discs, floppy discs, flash memories, or forms of electrically programmable memories (EPROM) or electrically erasable and programmable (EEPROM) memories.

In some examples, the techniques performed by computing device 24 described in this disclosure may also be embodied or encoded in an article of manufacture including a computer-readable storage media encoded with instructions. Instructions embedded or encoded in an article of manufacture including a computer-readable storage medium encoded, may cause one or more programmable processors, or other processors, to implement one or more of the techniques described herein, such as when instructions included or encoded in the computer-readable storage medium are executed by the one or more processors. Computer readable storage media may include random access memory (RAM), read only memory (ROM), programmable read only memory (PROM), erasable programmable read only memory (EPROM), electronically erasable programmable read only memory (EEPROM), flash memory, a hard disk, a compact disc ROM (CD-ROM), a floppy disk, a cassette, magnetic media, optical media, or other computer readable media. In some examples, an article of manufacture may include one or more computer-readable storage media.

In some examples, a computer-readable storage medium may include a non-transitory medium. The term “non-transitory” may indicate that the storage medium is not embodied in a carrier wave or a propagated signal. In certain examples, a non-transitory storage medium may store data that can, over time, change (e.g., in RAM or cache).

In some examples, storage device 28 may house one or more image libraries 32 used for comparing acquired digital images of composite component 12 as described further below. Additionally, or alternatively, storage device 28 may include automated inspection protocol 90 having instructions for caring out the inspection of composite component 12.

Computing device 24 may include additional components that, for clarity, are not shown in FIG. 2. For example, computing device 24 may include a power supply to provide power to the components of computing device 24. Similarly, the components of computing device 24 shown in FIG. 2 may not be necessary in every example of computing device 24.

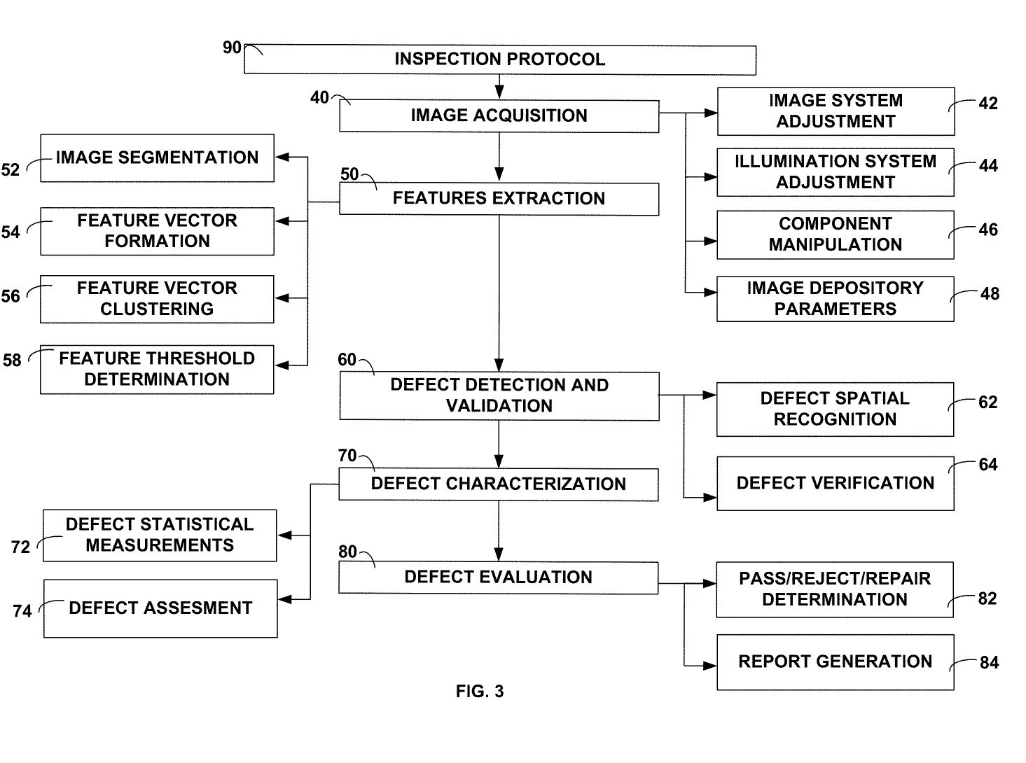

Examples of protocol based inspection system 10 and computing device 24 are described with reference to FIGS. 1 and 2 above, for a visual, non-destructive evaluation of a composite component 12. Example techniques for analyzing topical images of composite component 12 to determine the presence of one or more surface defects 14 performed by protocol based inspection system 10 are described with reference to FIG. 3 below.

FIG. 3 is a flow diagram illustrating an example automated inspection protocol 90 that may be performed by protocol-based inspection system 10. Automated inspection protocol 90 includes user selectable modules for performing various operational protocols to analyze composite component 12. Representative selectable modules may include, for example, image acquisition module 40, features extraction module 50, defect detections and validation module 60, defect characterization module 70, defect evaluation module 80, or the like. Each module may include one or more operational protocols (e.g., image system adjustment protocol 42) within each of the modules as described further below.

In some examples, protocol-based inspection system 10 may be configured to perform one or more of associated operational protocols of automated inspection protocol 90 automatically upon selection of the parent module (e.g., modules 40, 50, 60, 70, 80). Additionally, or alternatively, user interface 26 and automated inspection protocol 90 may be configured to allow the user, via user interface 26 to independently select one of more operational protocols within a module to be performed by protocol-based inspection system 10. Such user input may allow the user to perform specific operational protocols, repeat specific operation protocols, by-pass non-applicable operation protocols, or the like.

The various inspection protocols 30 can provide automated control for one or more components of protocol-based inspection system 10 including, for example, illumination system 16, imaging system 18, component mount 20, and the like. Once protocol-based inspection system 10 acquires a digital image of composite component 12, various inspection protocols 30 may be initiated to preform analysis of composite component 12 using computing device 24, for example, to assess the surface of composite component 12 for the presence of one or more surface defects 14. In some examples, automated inspection protocol 90 may include image processing algorithms and techniques implemented in system software of computing device 24. Automated inspection protocol 90 in conjunction with user interface 26 may offer intuitive and easy-to-use selectable, fully automated, adaptive, and customizable options to perform complex visual inspection of composite component 12 comparable to that of a human inspector.

Image acquisition module 40 may include any suitable operational protocol including for example, image system adjustment protocol 42, illumination system adjustment protocol 42, component manipulation protocol 46, images depository parameters protocol 48, or the like. In some examples, image system adjustment protocol 42 may include an adaptive image normalization process to improve the digital image quality of composite component 12. In some examples, such adaptive image normalization processes may include determining if composite component 12 is in focus and includes a proper contrast strength, border strength, edge strength, and noise strength to assess surface features of composite component 12; determining if portions of the composite component 12 are over saturated due to excessive shine prompting repositioning or adjustment of the brightness of illumination system 16; performing image background removal; and the like. In some examples, illumination system adjustment protocol 42 may include, for example, brightness adjustment of illumination system 16, directional positioning of illumination system 16 relative to composite component 12, or the like.

Component manipulation protocol 46 may include maneuvering composite component 12 using one or more servo motors 22 to expose one or more surfaces of composite component 12 for image capture by imaging system 18; adjusting the relative angle positioning between illumination system 16, composite component 12, and imaging system 18 to adjust for light reflections or improve contrast resolutions in the textured surface of composite component 12; and the like. In some examples, component manipulation protocol 46 may be fully automated, or semi-automated to allow the user to manually install or position composite component 12.

Image depository parameters protocol 48 may include selection of a storage medium 26 to store digital images of composite component 12; image classification and identification depending on the type of component and surface imaged; or the like. In some examples, the acquired images stored on storage device 28 may be compared against a stored library of representative images contained on storage device 28 to ensure proper image quality, saturation, and angle have been obtained for each digital image of composite component 12. In some examples, such representative images contained on storage device 28 may also be used to ensure proper component identification. Additionally, or alternatively, the user can specify how the system should display flaws in form of superimposed graphical details on the top of original inspection image(s) before such images are saved for post inspection image(s) retrieval.

In some examples, the different operational protocols of image acquisition module 40 may work in harmony to, based on the type of component imaged, acquire a desired set of imaged surfaces of composite component 12 for surface analysis and checking the quality of each acquired image. For example, illumination system adjustment protocol 42, image system adjustment protocol 42, and component manipulation protocol 46 may work in conjunction with one another to selectively image specific surfaces of composite component 12 in response to the identification of the type of component (e.g., air foil). In some examples, the identification of composite component 12 may be performed automatically as part of image acquisition module 40, or may be inputted by the operator via user interface 26.

Following the acquisition of one or more digital images of composite component 12, feature extraction module 50 may be performed. In some examples, feature extraction module 50 can be used to identify and remove segments of digital image of composite component 12 acquired with protocol-based inspection system 10 that may be deemed unnecessary or periphery (e.g., background regions or complex joint surfaces). In some examples, the removal of such segments may allow for an image with sharper edges for edge detection analysis or more uniform shading for defect detection analysis. Feature extraction module 50 may include any suitable operational protocol including for example, image segmentation protocol 52, feature vector formation protocol 54, feature vector clustering protocol 56, feature threshold determination protocol 58, and the like.

In some examples, image segmentation protocol 52 may include an image stitch process where two or more acquired images of overlapping portions of composite component 12 are digitally stitched together and normalized to illustrate a seamless transition between the acquired images. Additionally, or alternatively, image segmentation protocol 52 may include an option to allow the user to segment or select parts of the acquired digital images of composite component 12 for further analysis as part of automated inspection protocol 90. In some examples, the selected region or segment may be performed by selecting the area to be analyzed from a predetermined list of optional regions including, for example, the various flow surfaces, identified high stress regions, joint regions, coated rejoins, or the like. Additionally, or alternatively, user interface 26 may allow the user to manually select regions of the digital images of composite component 12 for further inspection. For example, as part of feature extraction module 50, the user may be able to apply a virtual mask to the acquired digital image of composite component 12 to either include or exclude selected areas for analysis. Additionally, or alternatively, image segmentation protocol 52 may allow the user to specify from a set list of pre-compiled regions that the inspection protocols 30 may provide depending on the type of composite component (e.g., airfoil) for image analysis.

Feature vector formation protocol 54 and feature vector clustering 56 operational protocols may include topical mapping of composite component 12 based on one or more of the acquired digital images, curvature characteristic modeling of the fiber/tow weaves based on the Lambertian illumination reflectivity differences associated with textured surface of the weaves, or the like.

In some examples, feature extraction module 50 may include one or more component character identifies that may be selected by the user to characterize the surface of composite component 12 to assist in preforming one or more of the feature vector formation protocol 54 or feature vector clustering protocol 56. For example, such component character identifiers may include selectable parameters to indicate that the imaged surface of composite component 12 includes a planar/convex/concave face, a leading/trailing edge, a cooling hole, ridge, fillet, a melt infiltrated surface, or the like.

Feature threshold determination protocol 58 may include applying an image enrichment technique to modulate the surface texture features and creates a wider discriminatory gap between normal surface texture features (e.g., a repetitive weave pattern) and those that have been identified as anomalous (e.g., disruptions in the textured surface). In some examples, the threshold determination may include a comparison of the digital image to a list of set or trained standards stored on user interface 26 to make a threshold determination whether the surface texture features of composite component 12 merits further defect analysis.

Once feature extraction module 50 has been conducted on composite component 12, defect detection and validation module 60 can be performed. Defect detection and validation module 60, may include any suitable operational protocol including for example, defect spatial recognition protocol 62, defect verification protocol 64, or the like. In some examples, defect spatial recognition protocol 62 may include performing spatial analysis on features identified as part of feature extraction module 50 warranting further review. For example, defect spatial recognition protocol 62 may include analyzing the surface features of the acquired digital image of composite component 12 to detect a surface pattern (e.g., weave pattern) using the repeat changes in the image color, brightness, saturation, or the like to determine if any inconsistencies or anomalies arise in the pattern indicative of a potential surface defect 14 (e.g., fiber tow mis-weave, broken weave, nodule growth, fissures or cracks in the surface, surface delamination, or other disturbances in the surface of composite component 12). Once an anomaly in the surface features has been flagged, defect verification protocol 64 may include of determination of false positives by, for example, comparing multiple digital images of the same surface region of composite component 12 to determine the flagged anomaly is present in two or more of the images. Additionally, or alternatively, defect verification protocol 64, for example, performing a fuzzy logic analysis to determine whether the flagged surface features deviate from a statistical norm by a statistically significant amount.

Defect characterization module 70, may include any suitable operational protocol including for example, defect statistical measurements protocol 72, defect assessment protocol 74, or the like. Defect statistical measurements protocol 72 may include performing statistical analysis on one or more identified defects 14 to assign quantitative values to flagged anomalies and defects 14 including, for example, size parameters such as height, depth, length, or width; geometrical values; quantity determinations; frequency determinations; or the like.

Defect assessment protocol 74 may include assigning one or more qualitative assessments to an identified surface defect 14 such as identify the type of surface defects 14 present. Such identification may be made using, for example, fuzzy logic analysis to perform qualitative reasoning using one or more parameters of the acquired digital image of composite component 12 including for example, the relative size of the surface feature, changes in color, contrast, or reflection, or the like. For example, mis-weaves in the tow (e.g., fiber tow mis-weave) may register as a relatively uniform disruption in an otherwise consistent surface pattern. Cracks or fractures may appear as roaming dark segments on the surface of composite component 12, typically with a non-linear (e.g., random) progression.

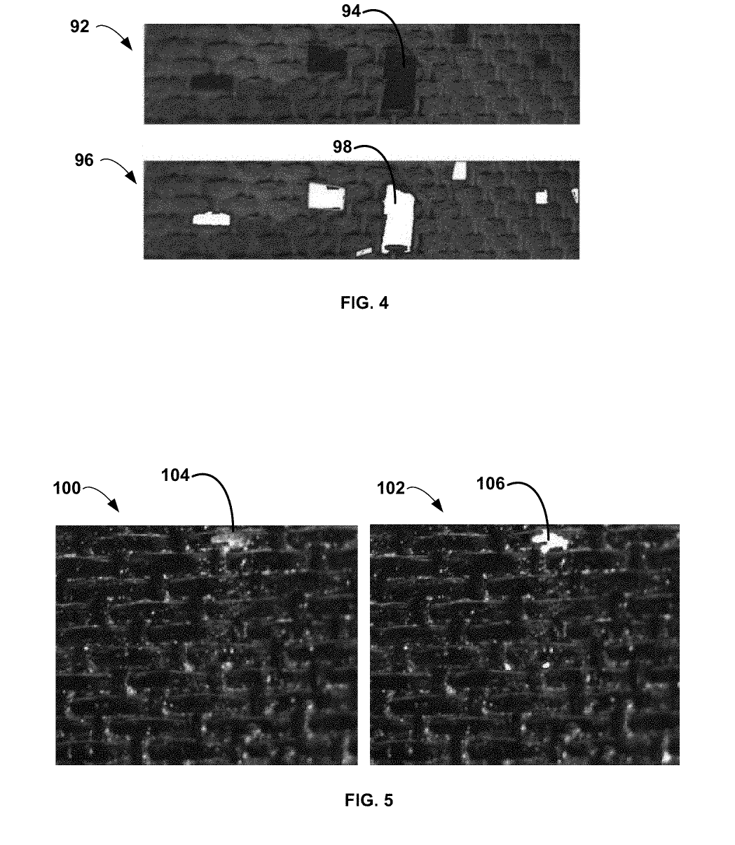

In some examples, where surface defects 14 represents insufficient coverage for the fiber/tow architecture of composite component 12, the coverage defects may exhibit a color reduction (e.g., dark regions) as the exposed fibers absorb more of the light compared to the metal infused counterparts. For example, FIG. 4 shows digital images taken of a CMC component that includes woven tows that have been infiltrated with silicon. Image 92 represents the digital image acquired of the CMC component that includes areas where the silicon has been insufficiently applied forming coverage defects 94. By performing fuzzy logic analysis or inference as part of defect assessment protocol 74, computing device 24 flagged defects 94 and identified them as coverage defects 98 (e.g., tow pops) as shown in processed image 96. The identification of coverage defects 98 was due, impart to the color of the defect.

In some examples, where surface defects 14 represents one or more nodules (e.g., silicon nodules), the extent of nodules may span across multiple tows, exhibit a domed shape having a high shine relative to surrounding features, and have a comparatively uniform color compared to the surface of the tows. For example, FIG. 5 shows digital images taken of a CMC component that includes woven tows that have been infiltrated with silicon. Image 100 represents a digital image acquired of the CMC component that included nodule defects 104. By performing fuzzy logic analysis as part of defect assessment protocol 74, computing device 24 flagged defects 104 and identified them as nodules 106 as shown in processed image 102. The identification of nodules 106 was due, impart to the size, reflectivity, shape, texture, and color of the defect.

In some examples, the image of the flagged surface defect 14 may be compared to a library of pre-identified defect images stored on storage device 28 to validate the identification of the flagged defect. In some examples, defect assessment protocol 74 may include preforming fuzzy-logic reasoning on digital image to provide qualitative assessments to an identified surface defect 14. Additionally, or alternatively, during defect assessment protocol 74, processing circuitry 28 of protocol-based inspection system 10 can compare the acquired images of composite component 12 at different angles to the same surface to validate the identification of an insufficient coverage surface defect 14. For example, the insufficient coverage for the fiber/tow architecture may be observed at specific imaging angles (e.g., head-on with high shine) and may be significantly muted or non-observant at other imaging angles (e.g., angles where illumination system 16 illuminates composite component 12 at glancing angles.

Defect evaluation module 80, may include any suitable operational protocol including for example, pass/reject/repair determination protocol 82, report generation protocol 84, or the like. Pass/reject/repair determination protocol 82 may include analyzing an identified surface defect 14 or collection of identified surface defects 14 to determine, for example, if surface defect(s) 14 compromise the integrity of composite component 12 necessitating a repair or reject determination, whether the type of surface defect(s) 14 can be repaired, whether additional testing needs to be conducted, or the like. After the analysis of composite component 12 has been concluded, report generation protocol 84 may generate a report of all the defect analyses performed on the component for user review. In some examples, the report may be a physical report indicating some or all of the identified anomalies and defects 14 of composite component 12. Additionally, or alternatively report generation protocol 84 may include storing a virtual representation of composite component 12 on storage device 28 registering and displaying one or more surfaces of composite component 12 with a defect map flagging identified anomalies and defects 14 and allowing the user to select a particular defect to review all generated quantitative and qualitative assessments. In some examples, such defect maps may include a 360-degree surface image of composite component 12 with anomalies and defects 14 registered about the defect map to allow the user to rotate and view a virtual rendering of composite component 12. The inspection system can register and maintain spatial locations of defects 14 in a traceable quad-tree format. The inspection system can also be capable of displaying historical inspection occurrence maps to allow the user to correlate defects with other input factors such as design and manufacturing parameters.

In some examples, modules 40, 50, 60, 70, 80 of automated inspection protocol 90 may be performed in a sequential order. Additionally, or alternatively, the user may select, via user interface 26, which modules to perform, in what order the modules should be performed, which operational protocols within each module should be performed, and the like.

In some examples, automated inspection protocol 90 may be modified or programed by the user using a learning module (not shown). In some such examples, the learning module may allow the user to develop a set of inspection standards, acceptance criteria, or the like that can be used by protocol-based inspection system 10 to determine whether an identified surface defect 14 on composite component 12 is within acceptable limits. Additionally, or alternatively, automated inspection protocol 90 may allow the user the option to incorporate aspects of the analysis and determinations made with respect to composite component 12 into storage device 28 for use as a comparative standard for automated inspection protocol 90 when one or more of the operational protocols are performed on a subsequent composite component.

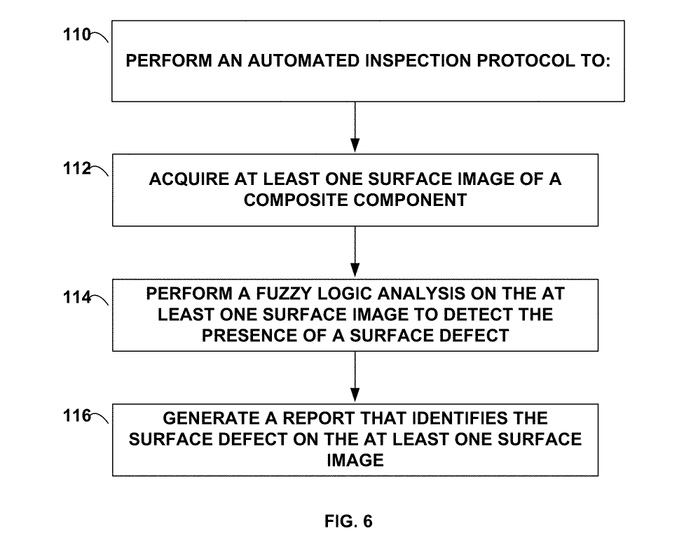

FIG. 6 is flow diagram illustrating an example technique for performing automated inspection protocol 90 using protocol-based inspection system 10. The technique of FIG. 6 includes performing an automated inspection protocol 90 (110) to acquire at least one surface image of composite component 12 (112), preform a fuzzy logic analysis on the at least one surface image of composite component 12 to detect the presence of surface defect 14 (114), and generate a report that identifies surface defect 14 on the at least one surface image (116).

As described above automated inspection protocol 90 may include a plurality of selectable modules including one or more of the images acquisition module 40, features extraction module 50, defect detection and validation module 60, defect character characterization module 70, or defect evaluation module 80, each including one or more operational protocols. In some examples, user interface 26 may be configured to allow the user the ability to select amongst the modules or operational protocols to be performed as part of automated inspection protocol 90.

In some examples, the techniques of FIG. 6 may be performed using protocol-based inspection system 10. In some such examples, performing the automated inspection protocol (100) may include using computing device 24 as part of the automated process to control or manipulate illumination system 16, imaging system 18, and component mount 20 to acquire at least one surface image of composite component 12 (112) in response performing automated inspection protocol 90 (100).

Various examples have been described. These and other examples are within the scope of the following claims.

What is claimed is:

1. A protocol-based inspection system comprising:
an illumination system;
an imaging system configured to capture a surface image of a composite component based on illumination of the composite component using visible light;
a component mount configured to rotate the composite component relative to at least the imaging system; and
a computing device configured to perform an automated inspection protocol to:
cause the illumination system to illuminate the composite component using visible light;
cause the imaging system to capture at least one surface image of the composite component in response to the illumination of the composite component using the visible light;
perform a fuzzy logic analysis on the at least one surface image to detect a surface defect on the composite component, wherein the surface defect comprises a fiber tow mis-weave, an exposed fiber tow, or a surface nodule; and
output an indication of the surface defect via a user interface.

2. The protocol-based inspection system of claim 1, wherein the automated inspection protocol includes a plurality of selectable modules, wherein the user interface is configured to allow the user to select at least one of the plurality of selectable modules, wherein the plurality of selectable modules comprises at least one of an image acquisition module, a feature extraction module, a defect detection and validation module, a defect characterization module, or a defect evaluation module.

3. The protocol-based inspection system of claim 2, wherein the plurality of selectable modules includes at least the image acquisition module, wherein the image acquisition module includes a plurality of operational protocols that the computing device performs to cause the illumination system to illuminate surfaces of the composite component, cause the component mount to rotate the composite component, and cause the imaging system to acquire the plurality of surface images of the composite component.

4. The protocol-based inspection system of claim 2, wherein the plurality of selectable modules includes at least the feature extraction module, wherein the feature extraction module includes an image segmentation operational protocol that the computing device performs to identify a segmented region of the at least one surface image for the computing device to perform on the segmented region the fuzzy logic analysis.

5. The protocol-based inspection system of claim 2, wherein the plurality of selectable modules includes at least the defect characterization module, wherein the defect characterization module includes a plurality of operational protocols including at least one of:
a defect statistical measurement operational protocol, wherein the computing device performs the defect statistical measurement operational protocol to quantify at least a length, a width, a height, or a depth of the surface defect; and
a defect assessment operational protocol, wherein the computing device performs the defect assessment operational protocol to identify the surface defect as a fiber tow mis-weave, an exposed fiber tow, or a surface nodule.

6. The protocol-based inspection system of claim 2, wherein the plurality of selectable modules includes at least the defect evaluation module, wherein the defect evaluation module includes a plurality of operational protocols including a pass-fail-reject determination operational protocol, wherein the computing device performs the pass-fail-reject determination operational protocol to determine whether the surface defect is within a tolerance limit or if the surface defect can be repaired.

7. The protocol-based inspection system of claim 1, wherein the computing device further comprises an image library comprising a plurality of stored images, wherein the computing device is configured to access the image library and compare the at least one surface image of the composite component to the plurality of stored images as part of the automated inspection protocol.

8. The protocol-based inspection system of claim 7, wherein the computing device is configured to access the image library and compare the at least one surface image of the composite component to the plurality of stored images to identify the surface defect as a fiber tow mis-weave, an exposed fiber tow, a surface nodule, or a crack.

9. The protocol-based inspection system of claim 1, wherein the computing device is configured receive an indication of an input from a user interface to perform the automated inspection protocol.

10. A method comprising:
receiving, by a computing device, an indication of an input from a user interface to select an automated inspection protocol;
causing, by the computing device, an illumination system to output visible light to illuminate a composite component using visible light;
causing, by the computing device, an imaging system to capture at least one surface image of the composite component in response to the illumination of the composite component using the visible light;
performing, by the computing device, a fuzzy logic analysis on the at least one surface image to detect a surface defect on the composite component, wherein the surface defect comprises a fiber tow mis-weave, an exposed fiber tow, or a surface nodule; and
outputting, by the computing device, an indication of the surface defect via the user interface.

11. The method of claim 10, further comprising causing, by the computing device, a component mount to maneuver the composite component to respective positions of a plurality of positions relative to the imaging system.

12. The method of claim 11, wherein causing the imaging system to capture the at least one surface image of the composite component comprises causing the imaging system to capture a respective surface image of the composite component at each respective position.

13. The method of claim 10, wherein preforming the fuzzy logic analysis on the at least one surface image of the composite component to detect the presence of the surface defect comprises using at least one of changes in color or contrast of the at least one surface image to detect the presence of the fiber tow mis-weave, the exposed fiber tow, or the surface nodule.

14. The method of claim 10, further comprising:
receiving, from the user interface, an indication of an input selecting at least one module from a plurality of selectable modules to be performed as part of the automated inspection protocol, wherein the plurality of selectable modules comprises at least one of an image acquisition module, a feature extraction module, a defect detection and validation module, a defect characterization module, or a defect evaluation module.

15. The method of claim 14, wherein the plurality of selectable modules includes at least the image acquisition module, wherein the image acquisition module includes a plurality of operational protocols that the computing device performs to cause the illumination system to illuminate surfaces of the composite component, cause the component mount to rotate the composite component, and cause the imaging system to acquire the plurality of surface images of the composite component.

16. The method of claim 14, wherein the plurality of selectable modules includes at least the feature extraction module, wherein the feature extraction module includes an image segmentation operational protocol that the computing device performs to identify a segmented region of the at least one surface image for the computing device to perform on the segmented region the fuzzy logic analysis.

17. The method of claim 14, wherein the plurality of selectable modules includes at least the defect characterization module, wherein the defect characterization module includes a plurality of operational protocols including at least one of:
a defect statistical measurement operational protocol, wherein the computing device performs the defect statistical measurement operational protocol to quantify at least a length, a width, a height, or a depth of the surface defect; and
a defect assessment operational protocol, wherein the computing device performs the defect assessment operational protocol to identify the surface defect as a fiber tow mis-weave, an exposed fiber tow, or a surface nodule.

18. The method of claim 10, further comprising:
performing, by the computing device, a pass-fail-reject determination on the surface defect to determine whether the surface defect is within a tolerance limit or whether the surface defect can be repaired; and
outputting, by the computing device, a result of the pass-fail-reject determination via the user interface.

19. The method of claim 10, further comprising forming composite component, wherein the composite component comprises a plurality of fibers and a ceramic matrix, wherein the composite component comprises at least one layer of woven fibers, and wherein the composite component defines a surface comprising the surface defect.

20. A computer readable storage medium comprising instructions that, when executed, cause at least one processor to:
receive, from an imaging system, at least one surface image of a composite component illuminated by visible light;
perform a fuzzy logic analysis on the at least one surface image to detect a surface defect on the composite component, wherein the surface defect comprises a fiber tow mis-weave, an exposed fiber tow, a surface nodule; and
output an indication of the surface defect via a user interface.
